(19) United States
(12) Patent Application Publication
(10) Pub. No.: US 2015/0377825 A1
(43) Pub. Date: Dec. 31, 2015

(54) CALIBRATION METHOD FOR BLOOD GLUCOSE OF BLOOD SAMPLE

(71) Applicant: DELBio, INC., Taoyuan City (TW)

(72) Inventors: Tsung-Hsuan TSAI, Taoyuan City (TW); Chien-Yu YIN, Taoyuan City (TW); Yi-An CHOU, Taoyuan City (TW)

(21) Appl. No.: 14/591,503

(22) Filed: Jan. 7, 2015

(30) Foreign Application Priority Data
Jun. 25, 2014 (TW) 103121860

(51) Int. Cl. G01N 27/416

(52) U.S. Cl. CPC G01N 27/4163

(57) ABSTRACT

A calibration method for blood glucose of a blood sample includes steps of: applying a first voltage to a blood sample to obtain a first blood glucose level; applying a second voltage to the blood sample to obtain a second blood glucose level; applying a third voltage to the blood sample to obtain a hematocrit index of the blood sample; and processing the hematocrit index and calibrating the second blood glucose level. The third voltage is higher than the first voltage. Through this disclosure, user can obtain a sensing current corresponding to the blood glucose level and a hematocrit index corresponding to blood sample by applying at least three-stage voltages within specific ranges to the blood sample, and further calibrate the blood glucose concentration according to the hematocrit index.

### CROSS REFERENCE TO RELATED APPLICATIONS

This Non-provisional application claims priority under 35 U.S.C. §119(a) on Patent Application No(s). 103121860 filed in Taiwan, Republic of China on Jun. 25, 2014, the entire contents of which are hereby incorporated by reference.

### BACKGROUND OF THE INVENTION

1. Field of Invention

The invention relates to a calibration method for blood glucose of a blood sample and, in particular, to a calibration method for blood glucose of a blood sample by at least applying three-stage voltages.

2. Related Art

The home health care is not only to monitor the real-time physiological status of patients, but also to bring many inspection items from hospital to patients' home. The most common testing items comprise the blood glucose testing.

However, the portable blood glucose meter used recently exist problem that always outputs with a greater error. The most influential factor about the error is the hematocrit (HCT) of blood samples which is varied by different ages and/or other situations. For example, new-born baby has a higher HCT resulting in under-estimated glucose levels when measured; the patients with dialysis have lower HCT resulting in over-estimated glucose levels when measured.

The methods recently used for testing the hematocrit comprise fluid-velocity method, spectroscopic method, filtration by membrane, and especially, the electrochemical method. The electrochemical method adopts electrochemical sensing strips to test the hematocrit of testing solution, and then, to compensate the blood glucose with numerical calculation to make testing result more close to the real value.

However, some electrochemical method still remains some limitations; for example, it needs to apply direct current (DC) and alternating current (AC) alternatively. In addition, the conventional strip structure is too complicated to simplify the manufacturing procedure. Otherwise, the accuracy of the self-testing results by patients is still not enough because of the error affected by the hematocrit of the blood sample and the method of the blood glucose compensation.

Briefly speaking, the electrochemical method still needs to be improved, especially for the aspects of testing the hematocrit and blood glucose compensation. This might have a great influence to the self-testing blood glucose techniques.

Therefore, it is an important subject to provide a calibration method which can effectively eliminate the influence of the glucose or interference on the blood glucose level and hematocrit so as to obtain more accurate hematocrit and further to calibrate the blood glucose level more accurately.

### SUMMARY OF THE INVENTION

In view of the foregoing subject, an objective of the invention is to provide a calibration method which can effectively eliminate the influence of the glucose or interference on the blood glucose level and hematocrit so as to obtain more accurate hematocrit and further to calibrate the blood glucose level more accurately.

To achieve the above objective, a calibration method for blood glucose of a blood sample according to the invention includes the steps of: applying a first voltage to a blood sample to obtain a first blood glucose level; applying a second voltage to the blood sample to obtain a second blood glucose level; applying a third voltage to the blood sample to obtain a hematocrit index of the blood sample; and processing the hematocrit index and calibrating the second blood glucose level. The third voltage is higher than the first voltage.

In one embodiment, the first voltage ranges between 0˜1V.

In one embodiment, the second voltage ranges between −1˜0V.

In one embodiment, the second voltage ranges between −0.9˜−0.1V.

In one embodiment, the application of the second voltage lasts for 0.5˜5 seconds.

In one embodiment, the third voltage ranges between 1˜4V.

In one embodiment, the application of the third voltage lasts for 0.5˜5 seconds.

In one embodiment, the first voltage, the second voltage and the third voltage are DC voltages.

In one embodiment, processing the hematocrit index is to obtain a hematocrit according to a linear relation.

As mentioned above, in the calibration method for the blood glucose of the blood sample of the invention, a blood sample is injected into an electrochemical strip, and a working electrode and an auxiliary electrode are disposed on the strip so that the electrochemical reaction can be implemented to the blood sample. By applying three-stage voltages within specific ranges to the working electrode, the sensing current corresponding to the original blood glucose level, the sensing current of the better blood glucose level without the influence of the interference, and the hematocrit index corresponding to the blood sample can be obtained, respectively, and therefore the calibration and compensation methods can be implemented to the original blood glucose concentration according to the hematocrit index for acquiring an accurate hematocrit (%).

In comparison with the conventional art, in the calibration method of the invention, a first voltage and a second voltage are sequentially applied to the blood sample to detect a first blood glucose level and a second blood glucose level of the blood sample, respectively. Since the second voltage applied to the blood sample is substantially a reverse voltage in relation to the first voltage, the influence of the interference in the blood sample upon the blood glucose concentration can be effectively eliminated, and therefore the accuracy of the second blood glucose level can be better than that of the first blood glucose level. Besides, in the calibration method of the invention, a third voltage, after the second voltage applied, is then applied to obtain the hematocrit index of the blood sample so as to achieve the calibration of the blood glucose level. Especially, wherein the first two-stage voltages are the input of DC voltage, additional several groups of electrodes can be omitted and also the AC voltage device can be omitted.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic flowchart of a calibration method for the blood glucose of a blood sample according to an embodiment of the invention;

FIG. 2A is a schematic exploded diagram of the strip used in the calibration method in FIG. 1;

FIG. 2B is a schematic block diagram of a measuring device working with the strip in FIG. 2A;

FIG. 3 is a schematic diagram showing the hematocrit index and the hematocrit have a linear relation;

FIG. 4 is a schematic diagram showing the linear regression distribution relation of the hematocrit index with different blood glucose concentrations;

FIGS. 5 and 6 are schematic diagrams showing the bias before and after compensating the blood glucose level by the hematocrit;

FIGS. 7A to 7M are schematic diagrams showing the glucose concentration and hematocrit measured by the calibration method of the invention applying the first voltage of 0˜1V;

FIGS. 8A to 8M are schematic diagrams showing the glucose concentration and hematocrit measured by the calibration method of the invention applying the second voltage of −1˜0V; and

FIGS. 9A to 9F are schematic diagrams showing the glucose concentration and hematocrit measured by the calibration method of the invention applying the third voltage of 1˜4V.

### DETAILED DESCRIPTION OF THE INVENTION

The present invention will be apparent from the following detailed description, which proceeds with reference to the accompanying drawings, wherein the same references relate to the same elements.

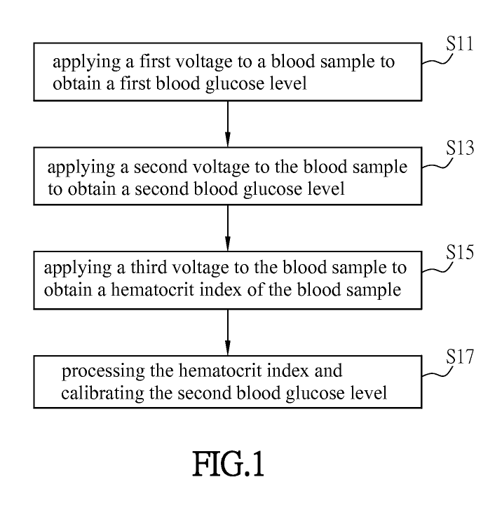

FIG. 1 is a schematic flowchart of a calibration method for the blood glucose of a blood sample according to an embodiment of the invention. As shown in FIG. 1, the calibration method of this embodiment includes the steps of: applying a first voltage to a blood sample to obtain a first blood glucose level (S11); applying a second voltage to the blood sample to obtain a second blood glucose level (S13); applying a third voltage to the blood sample to obtain a hematocrit index of the blood sample (S15); and processing the hematocrit index and calibrating the second blood glucose level (S17). The third voltage is higher than the first voltage.

For making the details of the steps of this embodiment clearer, the following illustration is given with the application of a device and the whole blood sample as an example. Besides, the structure of the device will also be illustrated and the calibration method of this embodiment will be illustrated accordingly. However, the following embodiments are just for the illustrative purpose but not for limiting the scope of the invention.

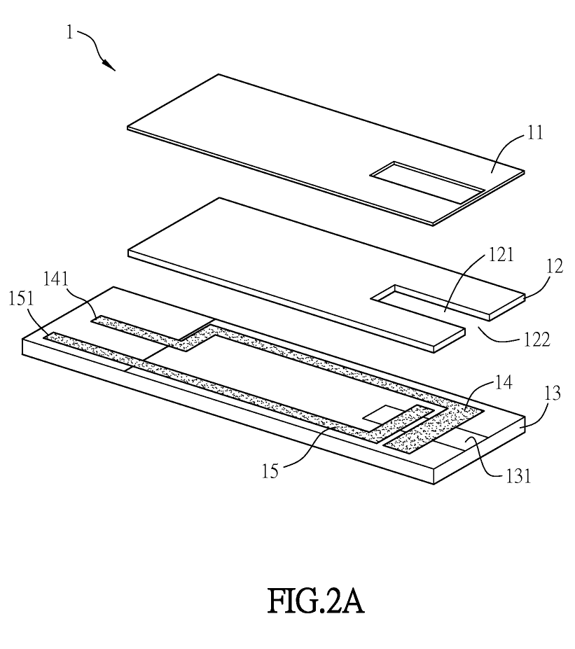

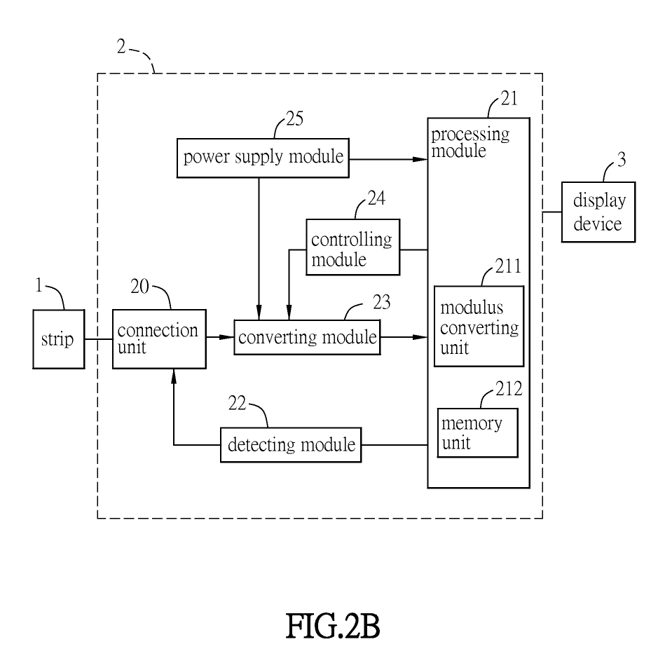

FIG. 2A is a schematic exploded diagram of the strip used in the calibration method in FIG. 1. As shown in FIG. 2A, in this embodiment, the strip 1 includes, as shown from top to bottom parts in figure, an upper cover layer 11, an intermediate layer 12, two electrodes, and a substrate layer 13. However, the above-mentioned structure and the relative position of the elements are not meant to be construed in a limiting sense. In other embodiments, the structure or disposition of the strip could be changed, or other components may be included inside the structure or set on the structure.

The substrate layer 13 is an electrical insulating substrate, which is, for example but not limited to, PVC (polyvinyl chloride), PS (polystyrene), polyester, polycarbonate, polyether, PE (polyethylene), polypropylene, PET (polyethylene terephthalate), silica or aluminum oxide. The two electrodes are a working electrode 14 and an auxiliary electrode 15. In this embodiment, the electrodes can be formed by a screen printing method and into a required pattern. The material of the working electrode 14 and auxiliary electrode 15 includes but not limited to carbon, unalloyed metal, alloy and/or other conductive material, for example. To be noted, the relative position, shape, and size of the working electrode 14 and auxiliary electrode 15 herein are not meant to be construed in a limiting sense.

As shown in FIG. 2A, one end along a longitudinal direction of the substrate layer 13 has a cathode 141 and an anode 151 which are respectively formed by the working electrode 14 and the auxiliary electrode 15, for example. Likewise, the relative position of the cathode 141 and anode 151 is not meant to be construed in a limiting sense and can be determined according to the connection with the electrochemical cell and the electron flow.

The other end along the longitudinal direction of the substrate layer 13 has a reaction portion 131, and at least both a part of the two electrodes cover the reaction portion 131. In an embodiment, the intermediate layer 12 is disposed on the substrate layer 13 and includes an injection hole 122 and an injection portion 121 which corresponding to the reaction portion 131. Wherein the injection hole 122 is at and edge of the injection portion 121. Since the intermediate layer 12 has a certain thickness, a space for accommodating the blood sample can be defined when the intermediate layer 12 and the substrate layer 13 are combined vertically. Therefore, when the blood sample enters through the injection hole 122 of the intermediate layer 12, then through the injection portion 121 of the intermediate layer 12, and finally fills the reaction portion 131, the working electrode 14 and the auxiliary electrode 15 can contact the blood sample within the space to result in the subsequent electrochemical reaction. Since the related electrochemical technique is comprehended by those skilled in the art, the related description is omitted here for conciseness.

However, the details of the electrochemical technique related to this embodiment are still mainly illustrated as below. A reagent is fixed or spread to the reaction portion 131 and made react with an under-test object in an under-test fluid to generate an electrochemical effect so as to generate an electrical output signal, which is related to the under-test object in the under-test fluid. In this embodiment, the under-test fluid is the whole blood of human, and the under-test object is hematocrit. The reagent used here includes at least an electron transmitting substance, which includes but not limited to tetrathiafulvalene, tetracyanoquinodimethan, meldola blue, potassium ferrocyanide, ferrocene or ferrocenedicarboxylic acid for example, and this invention is not limited thereto. Certainly, the reagent used here also can include enzyme, polymer or stabilizer which are reactive with the under-test object. However, this invention is also not limited thereto.

FIG. 2B is a schematic block diagram of a measuring device working with the strip in FIG. 2A. As shown in FIGS. 2A and 2B, the strip 1 is electrically connected to a measuring device 2. In an embodiment, the strip 1 is disposed in a connection unit 20 of the measuring device 2. The connection unit 20 is a trough that can accommodate at least part of the strip 1. Therefore, the size and shape of the connection unit 20 can be determined according to the strip 1.

In this embodiment, the measuring device 2 further includes at least a processing module 21, a detecting module 22, a converting module 23, a controlling module 24, and a power supply module 25. The detecting module 22 can detect if the strip 1 is disposed correctly in the connection unit 20 and report this status to the processing module 21. When the strip 1 is disposed in, the converting module 23 can convert the current signal generated by the strip 1 due to electrochemical effect into the voltage signal and transmit the voltage signal to the processing module 21 for the subsequent data calculation and determination. In this embodiment, since the blood sample of the strip 1 needs to be applied with three-stage voltages, the controlling module 24 of the measuring device 2 controlled by the processing module 21 will generate the voltage within the predetermined range for the converting module 23. Moreover, the voltages used in the measuring device 2 are supplied by the power supply module 25.

To be noted, the connecting relation and the composition of each element in the measuring device 2 are not meant to be construed in a limiting sense and can be adjusted according to the desired effect or requirement. The strip 1 is electrically connected to the measuring device 2 through the working electrode 14. The memory unit 212 of the processing unit 21 stores a plurality of linear relation data, which can be supplied for the processing module 21 to calculate the hematocrit tested from the blood sample and the calibrated blood glucose. Then, the display device 3 displays the calibrated blood glucose level for user to read out.

Accordingly, in an embodiment, when the blood sample is injected into the reaction portion 131 of the strip 1 and the strip 1 is disposed in the measuring device 2, the detecting module 22 will report this status to the processing module 21 and the processing module 21 will command the controlling module 24 to start to apply a predetermined voltage to the strip 1. In the step S11, the controlling module 24 commands the converting module 23 to apply a first voltage to the working electrode 14 and a first current can be generated between the working electrode 14 and the auxiliary electrode 15 thereby. Meanwhile, the first current can be converted by the converting module 23 and thus forms a first voltage curve. When the data of the first voltage curve is transmitted back to the processing module 21, the modulus converting unit 211 processes the first voltage curve according to the data stored in the memory unit 212 and obtain the first blood glucose level of the blood sample.

The first blood glucose level measured in the step S11 indicates the original blood glucose level in the blood sample. However, since some factor that will affect the measuring result, such as interference (e.g. impurity) excluded from the under-test object, exists in the blood sample, the first blood glucose level might be obtained with an error. Hence, in order to obtain the blood glucose concentration with higher accuracy, the above-mentioned interference needs to be treated properly. Besides, the first blood glucose level is also the value not calibrated by the hematocrit index.

Accordingly, in this embodiment, the step S13 is to apply a second voltage to the blood sample to obtain a second blood glucose level of the blood sample. In the step S13, just like the step S11, the processing module 21 commands the controlling module 24 to start to apply a predetermined voltage to the strip 1. As an embodiment, the controlling module 24 commands the converting module 23 to apply a second voltage to the working electrode 14 so that a second current can be generated between the working electrode 14 and the auxiliary electrode 15. Meanwhile, the second current can be converted by the converting module 23 and thus forms a second voltage curve. When the data of the second voltage curve is transmitted back to the processing module 21, the modulus converting unit 211 processes the second voltage curve according to the data stored in the memory unit 212 and obtain a second blood glucose level of the blood sample.

As an embodiment, the first voltage applied by the converting module 23 to the blood sample is in a range between 0 volt and 1 volt (V), and the first voltage can be 0.3V and be lasting for about 2 seconds (S), for example. Then, the second voltage is in a range between −1V˜0V, favorably is between −0.9V˜−0.1V, and furthermore, −0.3V is more favorably. To be noted, the range and favorable range of the first and second voltages comprise the sub-range of the above-mentioned ranges. As an embodiment, the first or second voltages last for about 0.5˜5 seconds favorably and for about 3 seconds more favorably.

Through the application of the two-stage voltages, the blood sample firstly undergoes the oxidization effect in the step S11, and then undergoes the reduction effect in the step S13, and therefore the interference existing in the blood sample can be effectively reduced, and the error in the blood glucose level caused by the interference can be eliminated. Therefore, in this embodiment, although the values measured in the steps S11 and S13 respectively are both blood glucose levels, the second blood glucose level obtained in the step S13 is closer to the actual blood glucose level than the first blood glucose level obtained in the step S11.

However, the second blood glucose level obtained in the step S13 is still not calibrated by the hematocrit index, and the hematocrit refers to the proportion (%) of red blood cell in a certain amount of blood. The measured level of the blood glucose will vary with the hematocrit. On the basis of 42% of the hematocrit for normal human, when the hematocrit is higher than 42%, the detected blood glucose level will be lower than that the real one; on the contrary, when the hematocrit is lower than 42%, the detected blood glucose level will be higher than that the real one. Hence, in order to obtain the more accurate blood glucose level, the hematocrit needs to be obtained first, and then the compensation for the blood glucose level can be implemented according to the hematocrit.

As mentioned above, most techniques are unable to obtain accurate hematocrit, and the blood glucose level and the hematocrit need to be obtained by the complicated processing steps, and then the data can be processed and the calibration can be implemented. This not only costs human power and meter processing time but also brings limited effect. However, in this embodiment, the step S15 as shown in FIG. 2A is to apply a third voltage to the blood sample to obtain a hematocrit index of the blood sample in sequence after the step S13.

In the step S15, the processing module 21 commands the controlling module 24 to apply a third voltage to the working electrode 14 so that a third current can be generated between the working electrode 14 and the auxiliary electrode 15. Meanwhile, the third current can be converted by the converting module 23 so as to form a third voltage curve. When the data of the third voltage curve is delivered back to the processing module 21, the modulus converting unit 211 processes the third voltage curve according to the data stored in the memory unit 212, and calculates a hematocrit index of the blood sample according to the third voltage curve. Then, the compensation for the measured concentration can be implemented according to the hematocrit index. Since the techniques and the implementation details of the calibration method can be comprehended by referring to the following experiments, they are not omitted here for conciseness.

Furthermore, the third voltage used to obtain the hematocrit index has the range of between 1˜4 volts (V), and wherein 3V is favorably. The application of the voltage lasts for about 0.5˜5 seconds (S), and for example, 3 seconds is favorably. In this embodiment, the second voltage and the third voltage have reverse polarities to each other, and the first voltage and the second voltage also have reverse polarities to each other. That means that the first voltage and the third voltage might have the same polarity. As an embodiment, the absolute value of the third voltage is greater than that of the first voltage.

Accordingly, by the second voltage applied in the step S13 and the third voltage applied in the step S15, the influence of the glucose concentration in the blood sample can be eliminated, and therefore the hematocrit index obtained in the step S15 can be more accurately adapted to calibrate glucose value. Thereby, the second blood glucose level that is obtained in the step S13 and a value closer to the actual blood glucose level can be calibrated by the more accurate hematocrit index obtained in the step S15, and the accuracy of the final measuring result can be thus enhanced.

To be noted, since the first, second and third voltages are all DC voltage inputs, in comparison with the conventional art where the DC voltage and AC voltage are alternately used as the input, the invention has the advantage of simplifying the measuring process and design of strip and measuring device.

As below will be shown, the experiments are given for illustrating the operation and effect of that the calibration method for blood glucose of the blood sample of the invention is applied to an organism and for demonstrating the effect that the error of the blood glucose level can be accurately compensated. To be noted, the following description illustrates the invention so that those skilled in the art can achieve the implementation, but is not meant to be construed in a limiting sense.

The obtaining method of blood sample of the embodiment comprises but not limited to: collecting the venous blood with the blood collection tube (Heparin Green), and rolling for 30 minutes for well-mixing with oxygen on the roller.

Experiment 1: Obtaining the Linear Relation Between the Hematocrit Index and the Hematocrit.

The operation comprises: preparing the same batch of the blood glucose strips, and the blood samples coming from the same blood specimen, then adjusting the blood glucose concentration of the blood sample to 175 mg/dL, and then processing three groups of blood samples with the hematocrit of 9%, 42% and 71% respectively for the experiment.

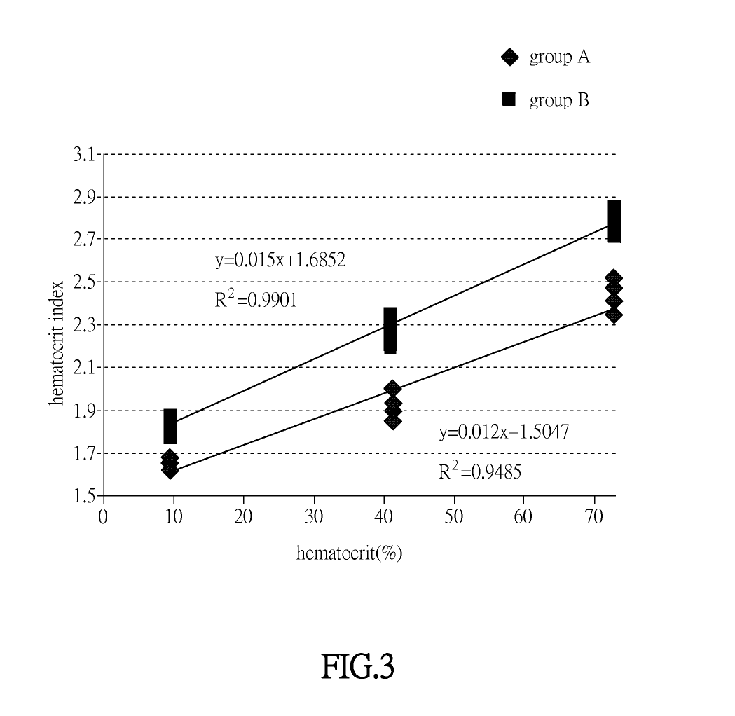

The three groups of the blood samples with the hematocrit of 9%, 42% and 71% respectively are all treated with two experimental conditions, wherein one is measuring the hematocrit index only by a high voltage stage (named group A), and the other is implementing the process with the calibration method of the invention (named group B). The used instrument is DELBio® meter or CH Instrument potentiostant. In detail, for the group A, under the room temperature (25±2° C., RH=60±5%), the blood sample of each hematocrit (9%, 42% and 71%) is applied with a first voltage by the DELBio® strip to obtain a first blood glucose level respectively, and then the blood sample is applied with a second voltage (3.2V) to obtain a hematocrit index of the blood sample respectively. For the group B, under the same room temperature as mentioned in group A, the blood sample of each hematocrit (9%, 42% and 71%) is applied with a first voltage by the DELBio® strip to obtain a first blood glucose level respectively, then the blood sample is applied with a second voltage to obtain a second blood glucose level respectively, and then the blood sample is applied with a third voltage to obtain a hematocrit index of the blood sample respectively. The result is shown in FIG. 3.

FIG. 3 is a schematic diagram showing the hematocrit index and the hematocrit have a linear relation. FIG. 3 shows the hematocrit index and the hematocrit of each of the groups A and B have a linear relation, and R² can be greater than 0.9 when the hematocrit ranges between 0˜70%. On the basis of such linear relation, the hematocrit can be indirectly calibrated or obtained by the obtained hematocrit index. The value of the measured hematocrit index of the group B is closer to the actual value.

Experiment 2: Linear Regression Distribution Relation of Hematocrit Index with Different Blood Glucose Concentrations.

The operation comprises: preparing the same batch of the blood glucose strips, and the blood samples coming from the same blood specimen, then adjusting the blood glucose concentration of the blood sample to 175 mg/dL, and then processing five groups of blood samples with the glucose concentration of 50 mg/dL, 175 mg/dL, 300 mg/dL, 470 mg/dL and 600 mg/dL for the experiment respectively.

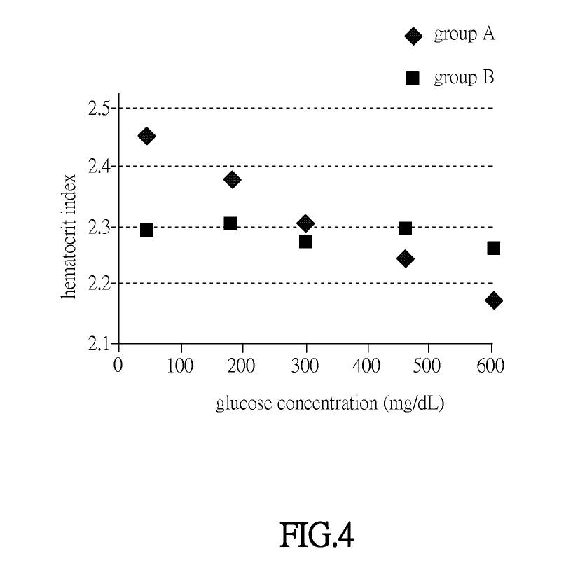

The above five groups of the blood samples with the glucose concentration of 50 mg/dL, 175 mg/dL, 300 mg/dL, 470 mg/dL and 600 mg/dL are treated with two experimental conditions (i.e. the conditions of the voltage application of the groups A and B). FIG. 4 is a schematic diagram showing the linear regression distribution relation of the hematocrit index with different blood glucose concentrations. From FIG. 4, it can tell that the hematocrit index obtained from the group B is less affected by the glucose concentration than the group A. In other words, when the glucose concentration ranges between 40˜600 mg/dL, the hematocrit index measured from the group B is less affected by the blood glucose concentration than that measured from the group A. Moreover, on the basis of such a linear relation, the hematocrit can be indirectly calibrated or obtained by the obtained hematocrit index.

Experiment 3: Compensating the Blood Glucose with the Hematocrit.

The operation comprises: preparing the same batch of the blood glucose strips, and the blood samples coming from the same blood specimen, then adjusting the blood glucose concentration of the blood sample to 175 mg/dL, and then processing three groups of blood samples with the hematocrit of 9%, 42% and 71% for the experiment respectively.

The three groups of the blood samples with the hematocrit of 9%, 42% and 71% are treated with three experimental conditions (i.e. the group without compensation, the group A with the compensation, and the group B with the compensation, respectively). In detail, for the group without compensation, under the room temperature, the blood sample of each hematocrit (9%, 42% and 71%) is applied with a first voltage by the DELBio® strip to obtain a blood glucose level. For the group A with the compensation, under the room temperature (25±2° C., RH=60±5%), the blood sample of each hematocrit (9%, 42% and 71%) is applied with a first voltage by the DELBio® strip to obtain a first blood glucose level, and then the blood sample is applied with a second voltage (3.2V) to obtain a hematocrit index of the blood sample, and then the first blood glucose level is compensated by the obtained hematocrit index to obtain a blood glucose level as the result of the group A with the compensation. For the group B with the compensation, under the room temperature, the blood sample of each hematocrit (9%, 42% and 71%) is applied with a first voltage by the DELBio® strip to obtain a first blood glucose level, then the blood sample is applied with a second voltage to obtain a second blood glucose level, then the blood sample is applied with a third voltage to obtain a hematocrit index of the blood sample, and then the second blood glucose level is compensated by the obtained hematocrit index to obtain a blood glucose level as the result of the group B with the compensation.

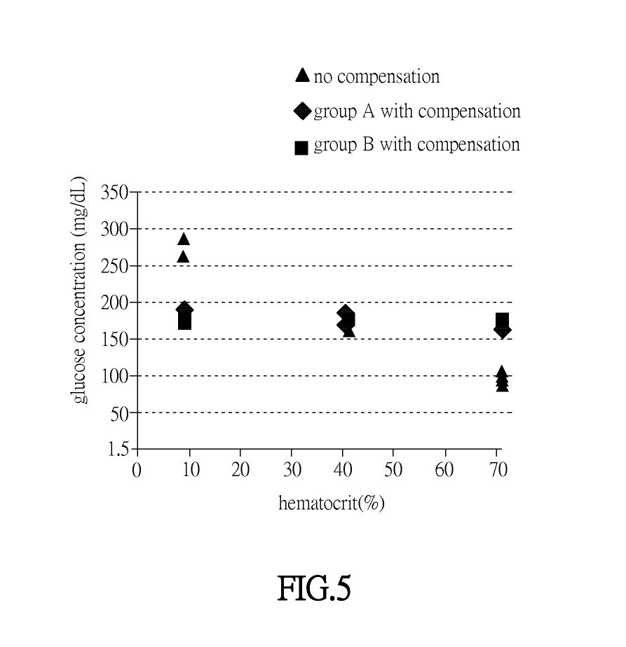

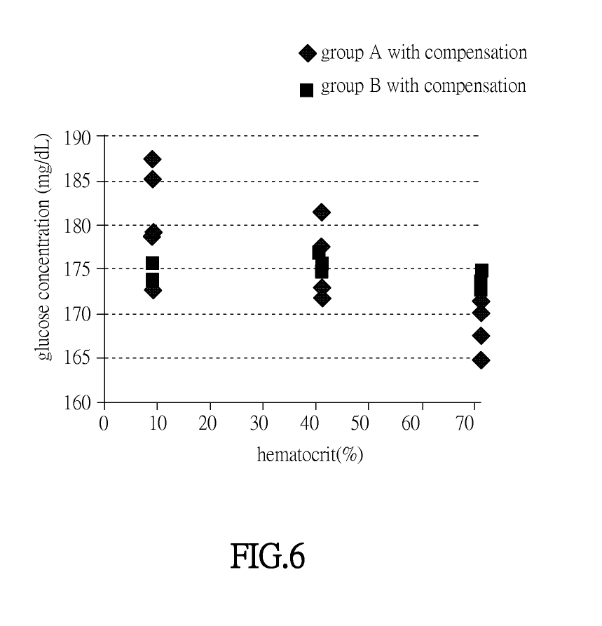

FIGS. 5 and 6 are schematic diagrams showing the bias before and after compensating the blood glucose level by the hematocrit. From FIG. 5, it can tell that each of the hematocrits corresponds to five data points, by regarding the average of the hematocrit of 42% as the basis (nearly 0% bias), when the hematocrit ranges between 0˜70%, the bias of the group without compensation will reach ±60%, but the bias of the groups A and B with the compensation can both be lowered down to ±10% or less, and the measuring result of the group B with the compensation is closer to the actual value (i.e. 175 mg/dL).

The result of the groups A and B with the compensation is further illustrated. As shown in FIG. 6, in the range of the hematocrit of between 0˜70%, the bias is reduced from ±8% to about ±4% and the variability (CV %) is reduced from 7% to 3%, which indicates that the group B with the compensation can correct the hematocrit index erroneously judged due to the glucose interference, and reduce the erroneous judgment about the concentration, and therefore the accuracy can be enhanced.

Experiment 4: The Glucose Concentration and Hematocrit Measured by the Calibration Method of the Invention Applying the First Voltage of 0˜1V.

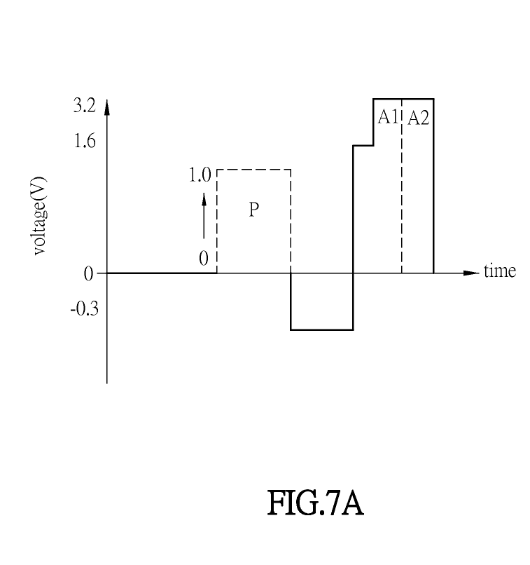

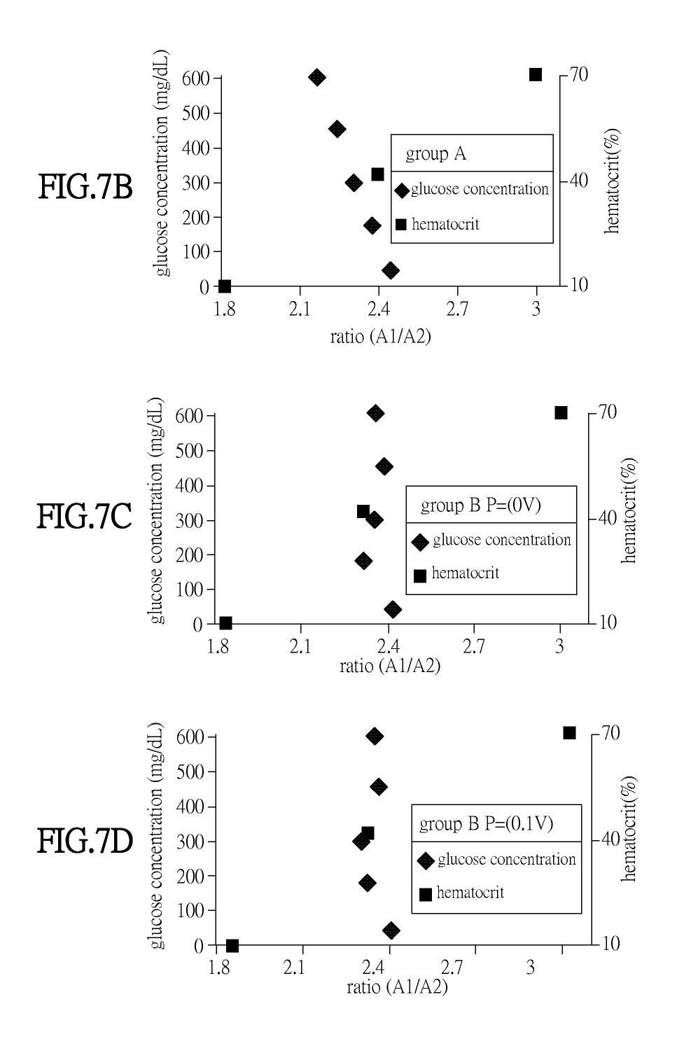

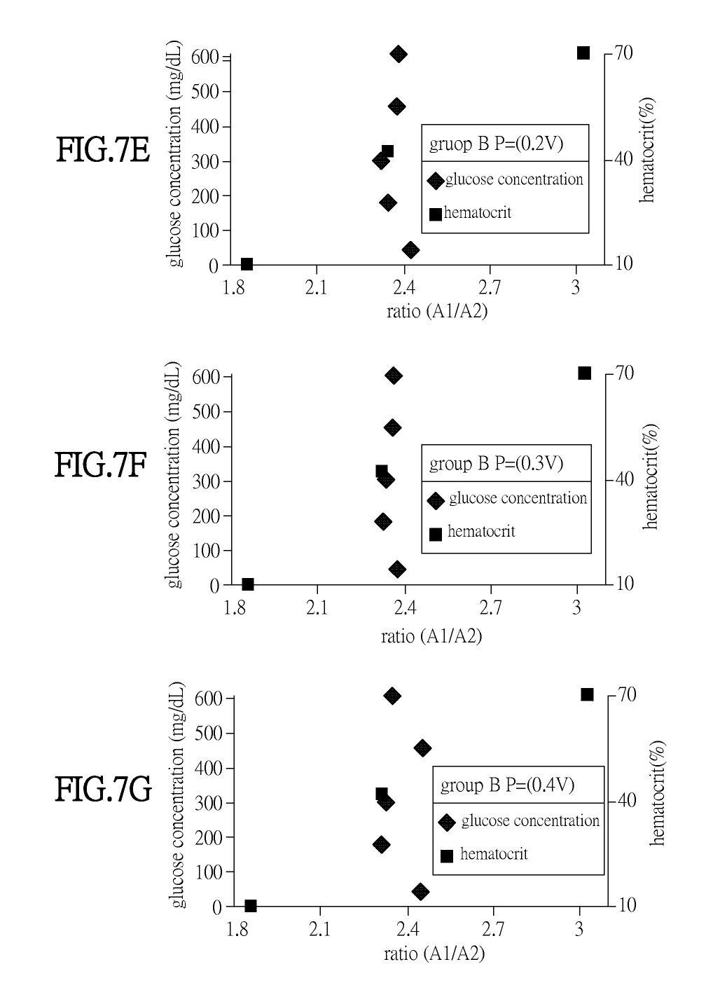

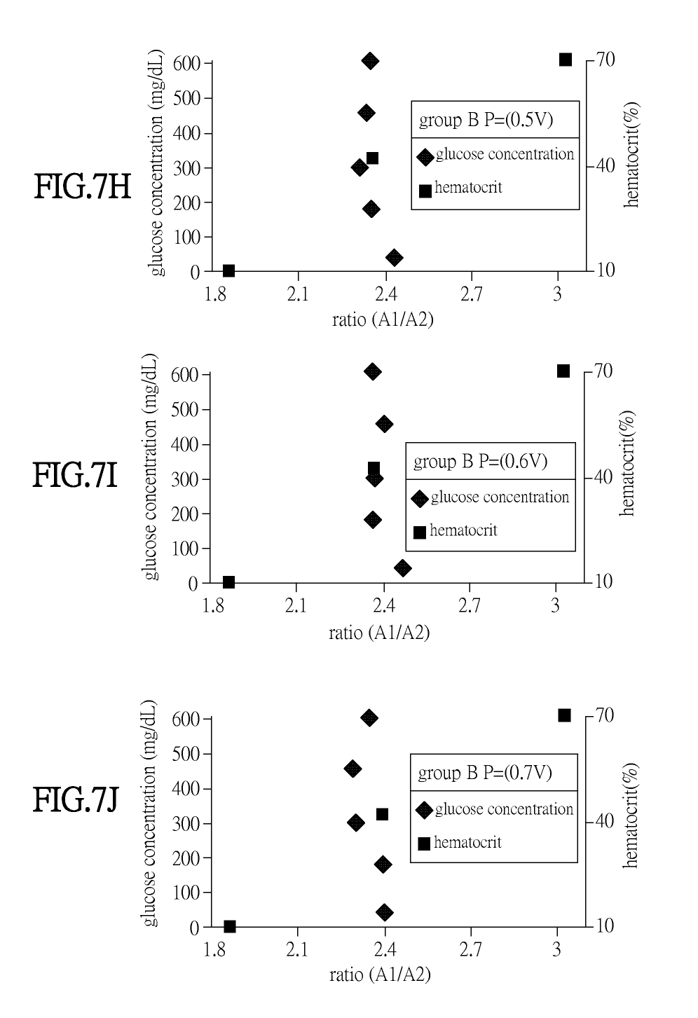

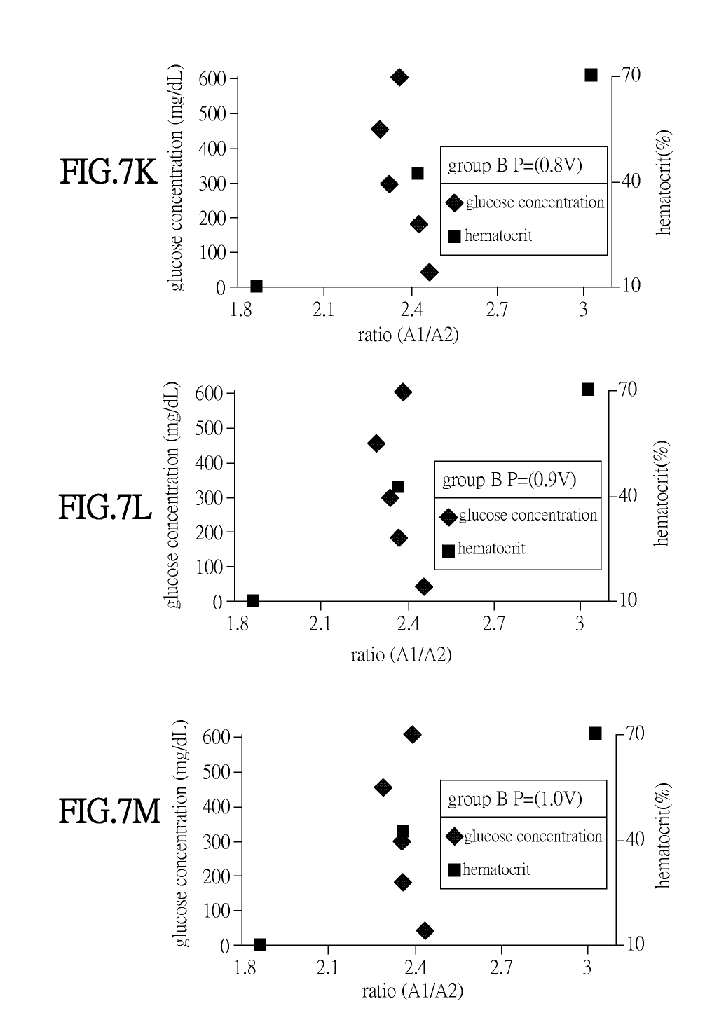

FIGS. 7A to 7M are schematic diagrams showing the glucose concentration and hematocrit measured by the calibration method of the invention applying the first voltage of 0˜1V. FIG. 7A is a schematic diagram of the voltage applied in an embodiment of the invention where the first voltage ranges between 0˜1V (i.e. the voltage of the stage P in FIG. 7A). FIG. 7B shows glucose concentration in group A. Each of FIGS. 7C˜7M shows glucose concentrations in group B, and wherein each voltage of stage P with difference of 0.1V to each other from range of 0V to 1.0V, respectively. As shown in FIGS. 7C˜7M, when the first voltage is 0V (as shown in FIG. 7C), the obtained hematocrit index will be affected by the glucose concentration. When the first voltage ranges between 0.1˜1V (as shown in FIGS. 7D˜7M, each with difference of 0.1V to each other in group B), the obtained hematocrit index will be less affected by the glucose concentration. When the first voltage is 0.3V, the obtained hematocrit index will be the least affected by the glucose concentration.

Experiment 5: The Glucose Concentration and Hematocrit Measured by the Calibration Method of the Invention Applying the Second Voltage of −1˜0V.

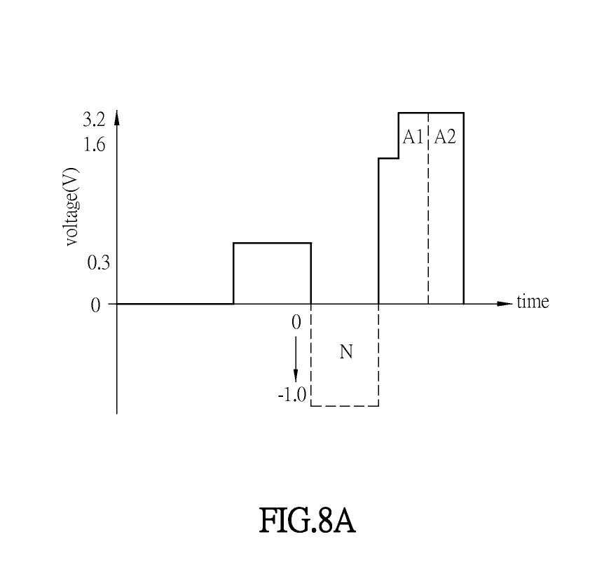

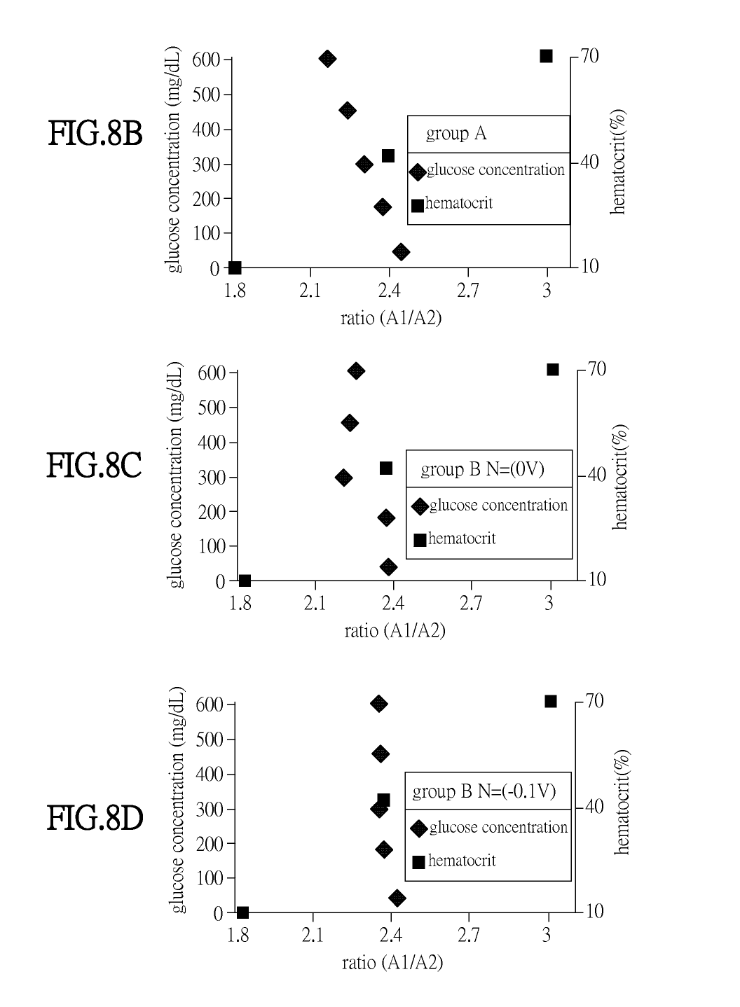

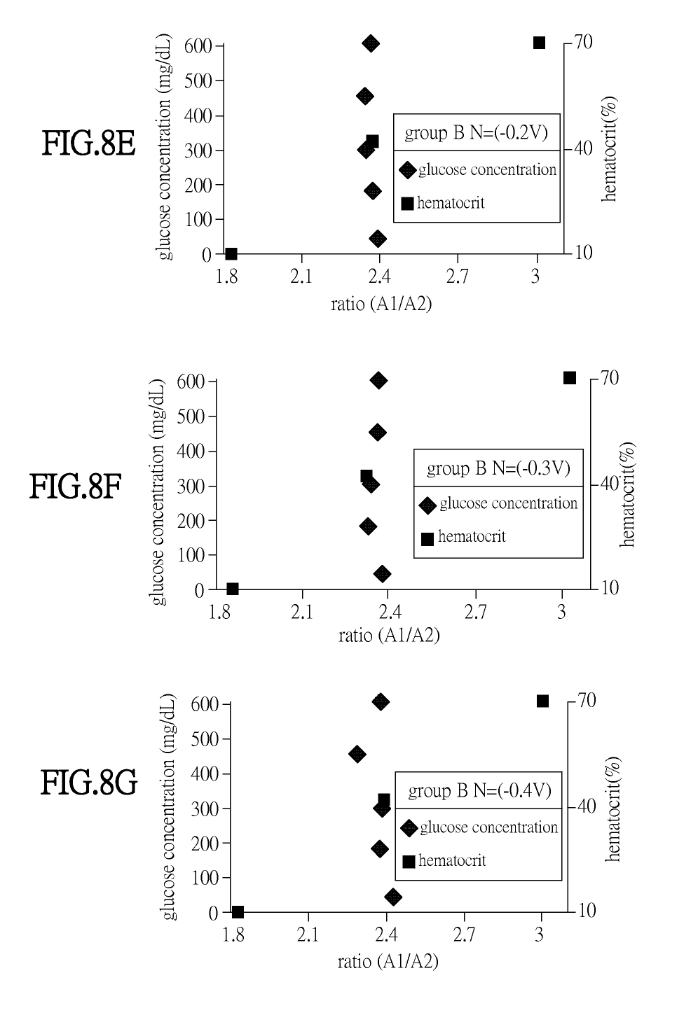

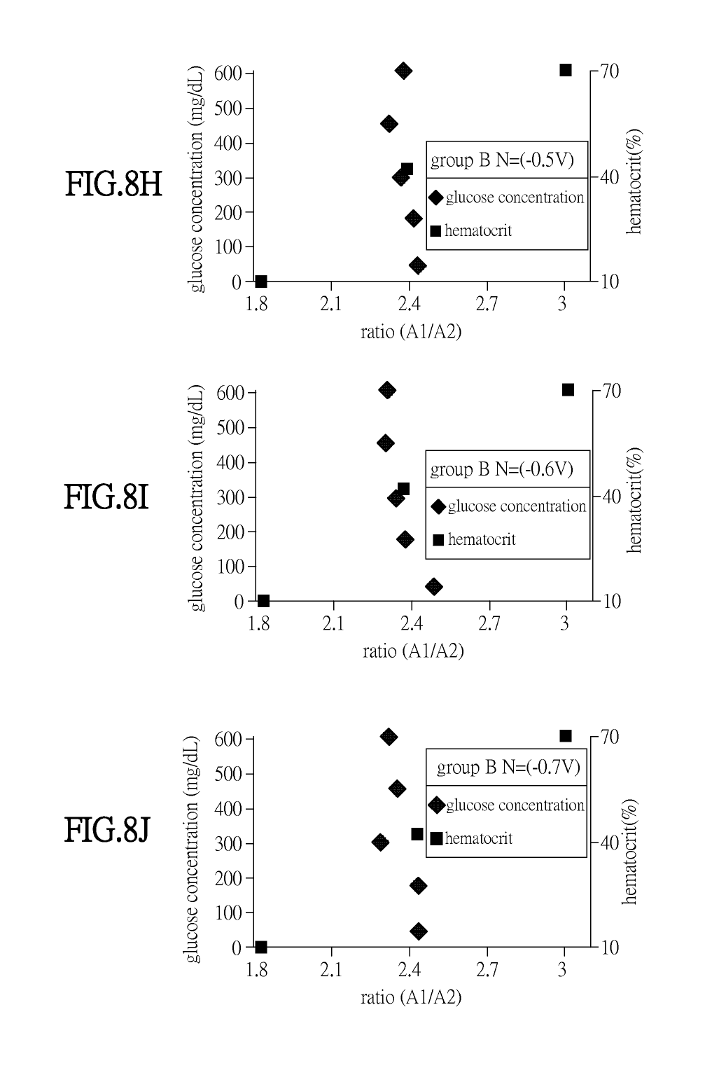

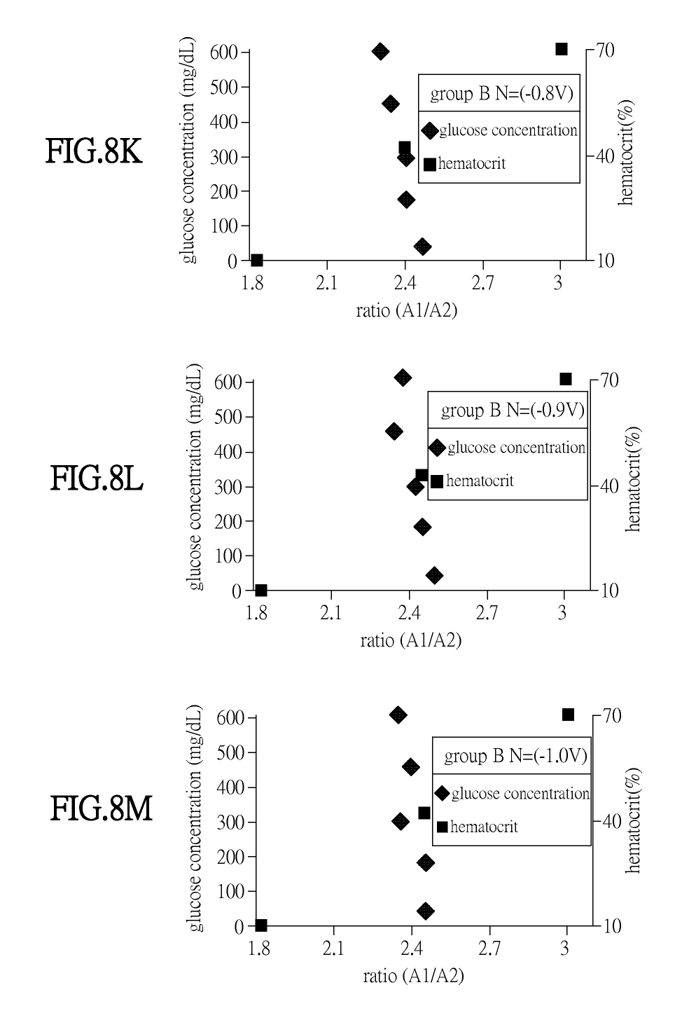

FIGS. 8A to 8M are schematic diagrams showing the glucose concentration and hematocrit measured by the calibration method of the invention applying the second voltage of −1˜0V. FIG. 8A is a schematic diagram of the voltage applied in an embodiment of the invention where the second voltage ranges between −1˜0V (i.e. the voltage of the stage N in FIG. 8A). FIG. 8B shows glucose concentration in group A. Each of FIGS. 8C˜8M shows glucose concentrations in group B, and wherein each voltage of stage N with difference of −0.1V to each other from range of 0V to −1.0V. As a result, when the second voltage is 0V (as shown in FIG. 8C in group B), the obtained hematocrit index will be affected by the glucose concentration. When the second voltage ranges between −1˜−0.1V (as shown in FIGS. 8D˜8M, each with difference of −0.1V to each other in group B), the obtained hematocrit index will be less affected by the glucose concentration. When the second voltage is −0.3V, the obtained hematocrit index will be the least affected by the glucose concentration.

Experiment 6: The Glucose Concentration and Hematocrit Measured by the Calibration Method of the Invention Applying the Third Voltage of 1˜4V.

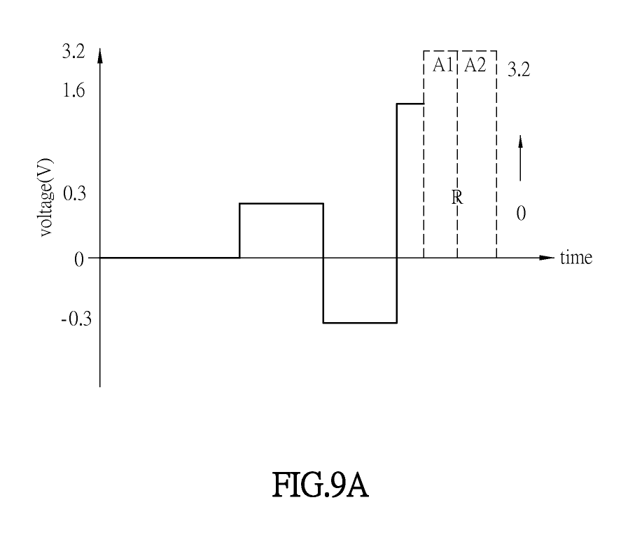

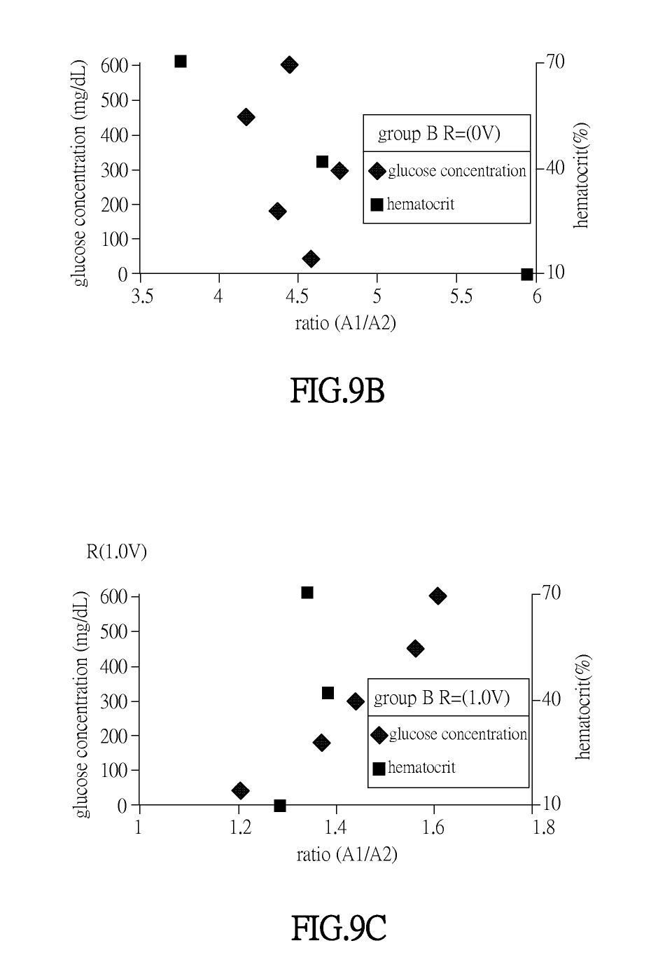

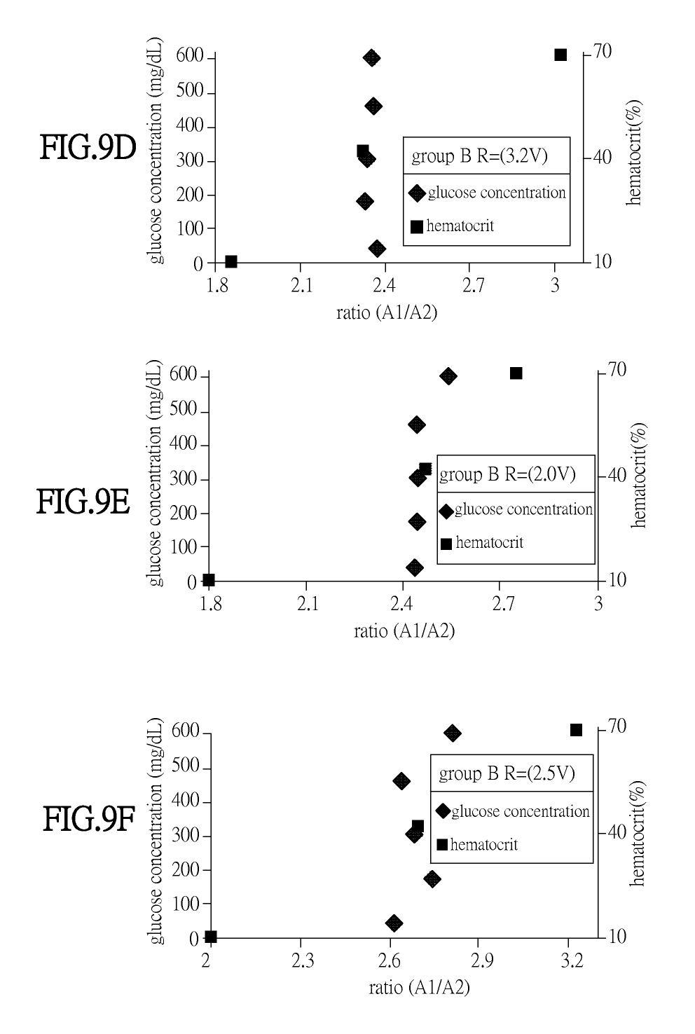

FIGS. 9A to 9F are schematic diagrams showing the glucose concentration and hematocrit measured by the calibration method of the invention applying the third voltage of 1˜4V. FIG. 9A is a schematic diagram of the voltage applied in an embodiment of the invention where the third voltage is 0, 1, 2, 2.5 and 3.2V (i.e. the voltage of the stage R in FIG. 9A). When the third voltage is 0V and 1V (as shown in FIGS. 9B and 9C respectively), the hematocrit index can not be measured and will be affected by the glucose concentration. When the third voltage is adjusted to 3.2V, 2V, and 2.5V (as shown in FIGS. 9D, 9E, and 9F), the hematocrit index can be measured, and the measured hematocrit is the least affected by the glucose concentration when the third voltage is 3.2V.

From the experiment, by the calibration method of the invention, the hematocrit of the blood sample can be effectively measured, and therefore the calibration of the blood glucose level can be achieved.

Summarily, in the calibration method for the blood glucose of the blood sample of the invention, a blood sample is injected into an electrochemical strip, and a working electrode and an auxiliary electrode are disposed on the strip so that the electrochemical reaction can be implemented to the blood sample. By applying three-stage voltages wherein each of them is within a specific range to the working electrode, the sensing current corresponding to the original blood glucose level, the sensing current of the better blood glucose level without the influence of the interference, and the hematocrit index corresponding to the blood sample can be obtained, respectively, and therefore the calibration and compensation can be implemented to the original blood glucose concentration according to the hematocrit index obtained for acquiring an accurate hematocrit (%).

In comparison with the conventional art, in the calibration method of the invention, a first voltage and a second voltage are sequentially applied to the blood sample to detect a first blood glucose level and a second blood glucose level of the blood sample. Since the second voltage applied to the blood sample is a reversed voltage in relation to that of the first voltage, the influence of the interference in the blood sample upon the blood glucose concentration can be effectively eliminated, and therefore the accuracy of the second blood glucose level can be better than that of the first blood glucose level. Besides, in the calibration method of the invention, a third voltage, after the second voltage applied, is further applied to obtain the hematocrit index of the blood sample so as to achieve the calibration of the blood glucose level. Especially, when the two-stage voltages are the input of DC voltages, additional several groups of electrodes can be omitted, and also the AC voltage device can be omitted.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A calibration method for blood glucose of a blood sample, comprising steps of:
applying a first voltage to a blood sample to obtain a first blood glucose level;
applying a second voltage to the blood sample to obtain a second blood glucose level;
applying a third voltage to the blood sample to obtain a hematocrit index of the blood sample; and
processing the hematocrit index and calibrating the second blood glucose level,
wherein the third voltage is higher than the first voltage.

2. The calibration method as recited in claim 1, wherein the first voltage ranges between 0˜1V.

3. The calibration method as recited in claim 1, wherein the second voltage ranges between −1˜0V.

4. The calibration method as recited in claim 3, wherein the second voltage ranges between −0.9˜−0.1V.

5. The calibration method as recited in claim 1, wherein the application of the second voltage lasts for 0.5˜5 seconds.

6. The calibration method as recited in claim 1, wherein the third voltage ranges between 1˜4V.

7. The calibration method as recited in claim 1, wherein the application of the third voltage lasts for 0.5˜5 seconds.

8. The calibration method as recited in claim 1, wherein the first voltage, the second voltage and the third voltage are DC voltages.

9. The calibration method as recited in claim 1, wherein processing the hematocrit index is to obtain a hematocrit according to a linear relation.
